(19) United States
(12) Patent Application Publication
(10) Pub. No.: US 2011/0001064 A1
(43) Pub. Date: Jan. 6, 2011

(54) Self tuning frequency generator

(76) Inventor: Howard Letovsky, Willits, CA (US)

Correspondence Address: HOWARD LETOVSKY, P.O. BOX 1925, WILLITS, CA, 95490, US

(21) Appl. No.: 12/807,593

(22) Filed: Sep. 8, 2010

Related U.S. Application Data
(63) Continuation-in-part of application No. 11/059,012, filed on Feb. 15, 2005.
Application No. 11/059,012 is a division of application No. 10/165,648, filed on Jun. 6, 2002, now abandoned.

(51) Int. Cl. G21K 1/00

(52) U.S. Cl. 250/503.1

(57) ABSTRACT

The present invention provides an apparatus which uses electromagnetic waves to identify and then quantifiably affect matter at the atomic and/or molecular level. The present invention generates frequencies that may range from DC to light waves and above, and then analyzes the transmitted, reflected, and absorbed interactions of said frequencies on any form of matter. The invention then defines and generates optimized combinations of said frequencies to create specific effects on said matter with a minimum of energy input and output.

This application is a continuation in part of, and repeats a substantial portion of, prior application Ser. No. 11/059,012, filed Feb. 15, 2005. This application deletes, as well as adds and claims additional disclosure not presented in the prior application. The referenced patent application Ser. No. 11/059,012 is in turn a divisional application of patent application Ser. No. 10/165,648, now abandoned, which was filed on Jun. 6, 2002.

### FIELD OF INVENTION

The present invention relates to frequency generators, spectrum analyzers, frequency amplifiers, lasers, microwave generators, transducers, spectrometers and other frequency generating and analyzing equipment.

Description of Prior Art

various devices are used to determine the atomic and molecular makeup of organic and inorganic substances. Gas chromatographs, gauss meters, emf meters, spectrum analyzers, magnetic resonance imaging systems, frequency counters, and thermal imaging systems, all fall into this field of prior art. It has also long been understood that frequencies in ranges from subsonic, ultrasonic, microwave, lasers, and all other segments of the audio and electromagnetic spectrum can have profound effects on matter. Wind moving over bridges at specific speeds and oscillations can cause the bridges to come apart. Atomic explosions have shown that the radiated electromagnetic waves can shut down electrical devices from great distances. Microwave ovens, magnetic resonance imaging, laser beam effects on biological tissues, and the classic example of a high “C” note shattering a glass are examples of other frequency effects can have on matter.

In the animal kingdom, dolphins use ultrasonic “sonar” senses to find hidden prey in the sea floor, as well as allegedly penetrate human bodies with healing frequencies. Recent evidence suggests that dogs may have the ability to “smell” cancer in humans.

Simpson's U.S. Pat. No. 5,377,163 describes a broadband acoustic sonar system designed to determine the species of various underwater life forms. Though Simpson's system embodies several of the elements of the present invention, it operates in a very narrow acoustic frequency range only, and is only designed to recognize various types of fish. In U.S. Pat. No. 5,343,443, Merewether discloses a broadband acoustic transducer which is used in various examples of prior art, and is exemplary of the types of sensors used in material recognition technologies. In U.S. Pat. No. 5,325,703, Magori discloses an apparatus and method for identifying the concentration of fuels or gases in air, by directing ultrasound through a mixture in the measuring section, and determining the speed of sound through the air/vapor mixture.

In the area of nuclear materials processing, General Electric Corporation has invested significant financial resources in its “SILEX” project which uses specific laser frequencies to enrich uranium.

In the area of food and medicinal plant cultivation, it has been advantageous to control the rate of growth of various parts of plants and their roots. The use of frequencies to produce these effects is gaining popularity.

Inducing a magnetic field in media that are normally non-magnetic is known in several areas of prior art. Eddy current generators use a spinning magnet to induce magnetic fields in aluminum and other metals. Static electrical generators, the principle of which can be simply demonstrated by combing one's hair and having the hair be attracted to the comb as it is pulled away—provide other means to induce attractive and repulsive forces.

In an article entitled, “Effects of Magnetic Fields on Germination and Plant Growth”, by K. Namba, A. Sasao, and S. Shibusawa, they described experiments with electromagnetic coils pulsed with frequencies on ‘Komatsuna’ plants. The frequency was varied from 1 to 1000 Hz, at a fixed intensity of 4 or 5 Gauss. Measured parameters were germination rate, growth rate and yield of the plant. The results indicated that frequency induced magnetic fields do influence plant growth and germination. Maximum germination rates, which were 20% higher than control rates, were obtained at around 10 Hz. An alternating magnetic field of 10 Hz was shown to have a statistically significant effect on plant growth, as measured by leaf area. The difference in growth rate between treated and control plants decreased after the field was removed.

A 2007 study presented at the sixth International Conference of the Balkan Physical Union entitled “The Effect of Electric Field Intensity on Bean Sprout Growing” by P. Kiatgamjorn, V. Tarateeraseth, W. Khan-ngern and S. Nitta. of the Research Center for Communications and Information Technology, Faculty of engineering, King Mongkut's Institute of Technology, Ladkrabang, Bangkok 10520, Thailand, showed that when bean plants were exposed to static magnetic fields, the plants grew larger and at a faster rate than without the magnetic fields. The bean sprouts were subjected to identical conditions without an electric field and with an electric field at 10 kV/m and 25 kV/m, respectively. The growing rate of the bean sprouts was observed every day for 5 days. The results also indicated that the bean sprouts under high electric field intensity showed better growth in comparison to the lower electric field intensity.

The limitations of all relevant prior art is that although certain systems can identify the atomic and/or molecular components of matter, and other systems can effect subtle changes in matter, no prior art system or apparatus can analyze the key characteristics of matter and subsequently generate frequency combinations and transmissions in real time to effect changes at the atomic and molecular level of said matter. The present invention provides that capability.

### SUMMARY OF THE INVENTION

The present invention provides an apparatus which uses frequencies to identify and then quantifiably affect matter at the atomic and/or molecular level. The present invention generates frequencies that may range from DC to light waves and above, and then analyzes the transmitted, reflected, and absorbed amplitudes following interactions of said frequencies on any form of matter. The invention then defines and generates optimized combinations of frequencies to create specific effects on said matter with a minimum of energy input and output.

A primary objective of the present invention is to release the energy that is naturally embodied within matter. The atomic bomb is one example of a massive energy release from radioactive matter that is catalyzed with a very crude trigger—a directed explosion that rams one radioactive material into another. Similar levels of energy release may be achieved with the present invention from non-radioactive matter—in a much more subtle way with a lot less noise and unwanted radioactive by-products. The present invention may also provide the capability to reactivate the radioactive output from “spent” uranium nuclear fuel rods.

Another objective of the present invention is to transform dangerous organic and inorganic compounds into non-toxic materials, such as neutralizing nuclear waste products, or toxic waste resulting from chemical manufacturing. The present invention may also provide a tool set to effect these transformations with a minimum amount of power consumption.

Another objective of the present invention is to stimulate the healing process in humans and animals. Scientists at the University of Alberta in Canada have successfully regenerated teeth from the root by the application of 1.5 megahertz pulses. Electrical bone growth stimulation is now common throughout the world using frequencies at 76.6 hertz, 40 kilohertz, and 1.5 megahertz to increase the speed of bone growth after a fracture or surgery. The present invention may provide a broad new range of frequency choices to further enhance the effectiveness of both tooth and bone regeneration devices.

Another objective of the present invention is to provide an improvement on microwave ovens. Currently, microwave ovens use a frequency of 2.45 gigahertz. By adding certain other frequencies, the power needed to operate said ovens could be dramatically reduced.

Recent research shows that radioactive decay rates, considered to be unique physical constants—and counted on in such fields as medicine and anthropology—may actually be variable. A team of scientists from Purdue and Stanford universities has found that the decay of radioactive isotopes fluctuates in sync with the rotation of the sun's core. The fluctuations appear to be very small but in the opinion of the research scientists—could lead to predictive tools for solar flares and may have an impact on medical radiation treatments. The researchers have ruled out the possibility of experimental error or an environmental influence on the detection systems that track the rate of decay as being responsible for the fluctuations and they have published a series of papers in the journals Astroparticle Physics, Nuclear Instruments and Methods in Physics Research, and Space Science Reviews.

The sun's rays that reach the earth that are considered responsible for these half-life change effects, contain light and electromagnetic energy, therefore, it is reasonable to surmise that the correct, controlled, application of light and/or electromagnetic energy can effect the behavior of radioactive materials in different, more extreme ways that the subtle effects of relatively steady solar radiation. The present invention provides an apparatus which may create and optimize these desired effects.

Uranium Enrichment is a technically difficult process, and is essential to producing fuel for the global Nuclear Power industry, which currently provides approximately 16% of the world's electricity. The SILEX Uranium Enrichment Process technology utilizes lasers to separate or enrich the naturally occurring isotopes of an element to create ‘new’ materials with different qualities (This statement is from GE). Separation of Isotopes by Laser Excitation (SILEX) is an Australian development that GE Hitachi Nuclear Energy (GEH) is preparing for commercialization. SILEX has been indicated to be an order of magnitude more efficient than existing production techniques but the exact figure is classified.

The SILEX technology uses specific frequencies of laser light, and does not incorporate the self adjusting and multiple frequency functionality of the present invention. However, the SILEX usage of electromagnetic frequency (laser Light) to affect radioactive energy output essentially validates the disclosures in my patent application #11059012, of which this application of the present invention is a continuation in part. The SILEX research also validates the suppositions and disclosures in my original parent patent application Ser. No. #10/165,648 where I contended that transformations of atomic structures were possible with frequency application. The present application is a continuation in part of my application Ser. No. #11/059,012, which is a divisional application of my application Ser. No. #10/165,648.

DNA electrophoresis is an analytical technique used to separate DNA fragments by size. DNA molecules which are to be analyzed are set upon a viscous medium, the gel, where an electric field forces the DNA to migrate toward the positive potential, the anode, due to the net negative charge of the phosphate backbone of the DNA chain. The DNA fragments of different lengths are visualized using a fluorescent dye specific for DNA, such as ethidium bromide. This is another example of the interaction between electric fields and biological tissues.

Cold lasers are used everywhere from bar code scanners to CD players. Laser light therapy has a 40 year proven track record throughout the world. Canada has been using cold lasers for pain management and smoking cessation for over 22 years. In 2002, the Erchonia lasers received the first cold laser FDA clearance for pain and since then up to 26 different cold laser and light emitting devices have received FDA clearance.

Lasers are used in eye surgery for vision correction, the laser scalpel is used in general surgery, gynecological, urology, laparoscopic, and photobiomodulation procedures, the removal of tumors—especially of the brain and spinal cord, in dentistry for caries removal and endodontic/periodontic procedures, tooth whitening, and oral surgery.

Lasers have been proven to increase cell metabolism, increase collagen synthesis for increased healing of soft tissues, increase osteoblast production for increased healing of bone, increase circulation through increased formation of new capillaries by release of growth factors, increase T-cell production for increased immune function, increase production of neurotransmitters such as endorphins, serotonin, ACTH etc., and increase chronic pain threshold through decreased C-fiber activity. The laser energy is absorbed by metabolically active pigments of the mitochondria in various cutaneous and subcutaneous layers. The changes in the stereo-chemical conformation induced by an electro magnetic field, improves the concentration of ATP by up to 200%. In addition, an increase in oxygen and glucose metabolism occurs. The main effect is an optimized function of the Na—K pump at the cell membrane, an increased protein synthesis (prostaglandin, enzyme) and a significantly higher rate of mitosis.

NASA is currently using Laser light therapy for medical conditions in space. All of these validate the growing acceptance in mainstream medicine for the medical efficacy of laser therapy as a viable, often superior therapeutic treatment modality.

It is reasonable to conclude that since animal tissue is reactive to many wavelengths of laser light in numerous known ways, and laser light represents just a small segment of the frequency spectrum, other as yet unknown reactions and effects may be catalyzed by subtle and precise manipulation of various wavelengths of laser light and other frequencies. The present invention provides an apparatus to generate these frequencies for the purposes of affecting organic and inorganic substances.

The present invention integrates broadband frequency generators, transducers, sensors, frequency amplitude analyzers (spectrum analyzers), photometers, computers, and computer software, as well as other specific components, to first determine the atomic and/or molecular structure of a given organic or inorganic substance, then determine a set of “active” frequencies relevant to said substance through computer analysis of the effects of said frequencies on a given substance, and then generate an appropriate “new” set of modified frequencies to be applied to a substance to achieve a desired result.

The invention as described herein has many advantages over prior art. A more complete understanding of the present invention, as well as further features and advantages, will be obtained by reference to the following detailed description and drawings. Preferred embodiments of the present invention will be described in the dependent claims.

### BRIEF DESCRIPTION OF THE DRAWINGS

FIG. 1 illustrates a pictorial view of an exemplary apparatus for determining and modifying the electromagnetic characteristics of matter within a specimen chamber.

FIG. 2 illustrates a pictorial view of an exemplary apparatus for determining and modifying the electromagnetic characteristics of matter without using a specimen chamber.

### DESCRIPTION OF THE INVENTION

The periodic table of elements maps both the differences and similarities between different forms of matter. All atomic elements are typically described as including protons, electrons, and neutrons. While the sub-components may be identical, the number and arrangements of said sub-components differentiate one atomic element from another. Further, the arrangements of combinations of elements differentiate one molecule from another.

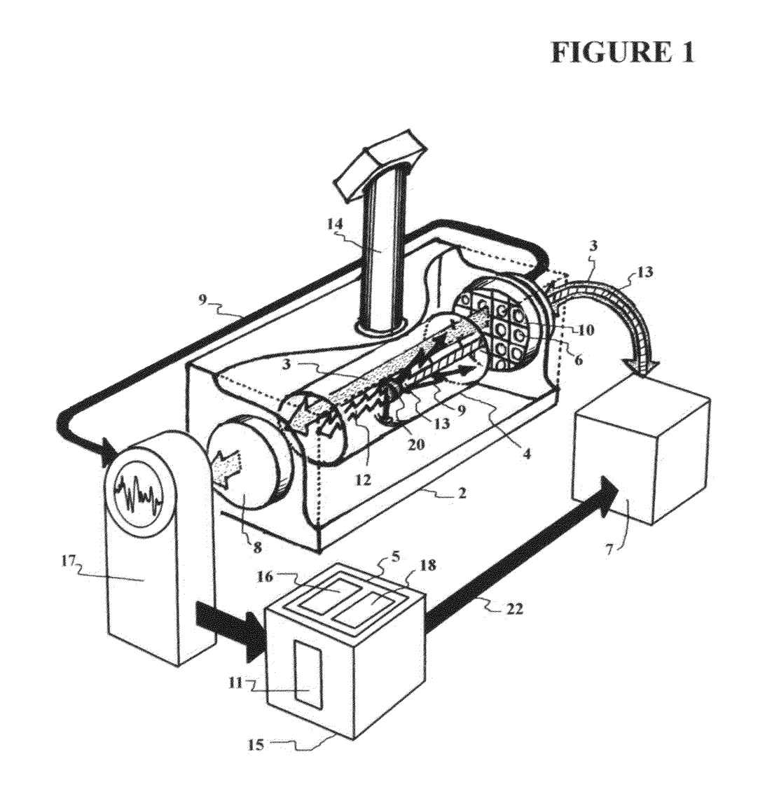

The preferred embodiment of the present invention as shown in FIG. 1 is intended to identify atomic and/or molecular structures by transmitting frequency waves drawn from the full range of the frequency spectrum through said atomic and molecular structures, and then analyzing the amplitudes and other measurable characteristics of the transmitted, reflected, and absorbed frequency waves as a result of said transmissions being passed trough said atomic and/or molecular structures. The present invention may then use both open and closed loop frequency feedback apparatus to manipulate said full range of the frequency spectrum, and re-transmit variations of said transmitted, reflected, and absorbed frequency waves through said atomic and molecular structures to affect and modify said structures.

It is well known that matter can be affected by single or combinations of frequencies to achieve a simple result. Crystal can be shattered with the application of a “high C” audio tone. But if the goal were to melt or vaporize the crystal, the present invention may be used to activate and transmit a base frequency other than “high C”, combined with an assortment of multi-order harmonics, frequency inversions, and dissonant frequencies relative to said base frequency.

In the preferred embodiment of the present invention as represented by FIG. 1, a material analysis chamber 2 is provided as an elongated hollow box configured to house a removable specimen-positioning element 4, an array of broadband frequency transmitting transducers 6, an array of broadband frequency receiving transducers 8, and an array of broadband frequency receiving transducers 10 (placed in a different location, but functionally equivalent to transducers 8). Said receiving and transmitting transducers 6, 8, and 10 are mechanically coupled to the interior of material analysis chamber 2, and are well known in prior art as magnetic, piezo-electric, photo sensitive, acoustic, or mechanical vibration sensing devices, so there is no need to go into specific detail of their makeup herein.

Transducers 10 are mounted interstitially around broadband frequency transmitting transducers 6 to sense reflected frequency waves 9 that radiate back from any specimen 20 following generation of broadband frequency waves 3 by frequency generator 7. Chamber 2 should have solid walls, but its interior should ideally be rendered frequency neutral with internally mounted sound and light deadening material such as black anechoic foam backed by surface mottled and pocked Mu-metal.

Removable specimen-positioning element 4 may be configured to hold solids, fluids, or gasses comprising a specimen 20. Element 4 may be a clamp, cup, tube, or closed vessel as required. The frequency analysis capabilities of the present invention allow both the recognition and frequency neutralization of the removable specimen-positioning element 4 and the chamber 2 by software subtraction of their frequency characteristics from those of any given specimen 20. An opening in chamber 2, allowing visual access to removable specimen-positioning element 4, may be provided to allow an electron-tunneling microscope 14—or similar test instrument—to be used to observe the effects of the invention on any given specimen 20 contained by element 4 in real time.

Broadband frequency generator 7 is maintained outside of material analysis chamber 2, but is electrically coupled to transducers 6, and is capable of generating a variable amplitude, variable wave shape, single or multiple component frequency set 3, said set 3 further capable of including DC frequencies and above—combined with single or multiple harmonics, inversions, and/or dissonances of said frequency set 3 at variable amplitudes and wave forms. Transducers 6 are configured to transmit and project said frequency set 3 provided by generator 7 at, and through, any specimen 20. Frequency receiving transducers 8 and 10 are configured to sense any transmitted frequency set 12, and/or any reflected frequency set 9—both which are essentially subsets of set 3, but at variations in amplitude, wave shape, and potentially magnetic characteristics, that either pass through, or are rejected by, any specimen 20.

Frequency receiving transducers 8 and 10, and frequency transmitting transducers 6, may be configured as an array of multiple units, each optimized for certain parts of the frequency spectrum. However, their combined sensing capabilities may include every frequency, or combinations of every frequency, as well as harmonics, inversions, and dissonances of said frequencies spanning the subsonic, sound, light, radio, and other electromagnetic wavelength spectra.

Frequency analyzer 17 (which, for purposes of the present invention, may also be a frequency amplitude sensor, spectrum analyzer, guass meter, mass spectrometer, photometer, spectrometer, frequency counter, or any other frequency measuring tool) is electrically coupled to transducers 8 and 10, as well as computer processing system 15 through an electrical connection 22, and performs frequency amplitude, counting, wave form, and magnetic analysis, on said frequency sets 3, 9, and 12. Hardware and software spectrum and frequency analyzers, as well as computers, are well known in prior art, so there is no need to go into great detail on these components.

Computer processing system 15 is electrically coupled to generator 7 through an electrical connection 22, and may incorporate a software algorithm 11 configured to direct computer system 15 to quantify, specify, and modify any frequency, wave form, and amplitude of said frequency outputs of generator 7 and said frequency sets 3, 9, and 12 sensed by transducers 8 and 10.

The combination of frequency analyzer 17 and system 15 is configured to quantify the absorbed, reflected, and transmitted, single or multiple frequency sets 3, 9, and 12 created by generator 7 and sensed by transducers 8, and 10. Since the frequency output of broadband frequency generator 7 is known data within system 15, the specific frequencies of set 3 and energy component of said frequencies absorbed by specimen 20 can be determined by algorithm 11 of system 15 that adds together the reflected and transmitted frequencies in all spectra received by transducers 8 and 10 and subtracts them from the total applied broadband frequency set 3.

A modified frequency feedback set 16 may be created by retransmitting only the absorbed frequency waves 13 defined by system 15, and classifying the resultant changes in the associated reflected and transmitted frequency waves 9 and 12. Said set 16 may be configured as a software subset of database 5 as “active natural resonant” frequencies that may be applied to any given specimen 20. The active natural resonant frequency makeup of the atomic and molecular structure of a specimen 20 can then be defined by comparing the resultant data quantified by computer processing system 15 with its resident atomic and molecular identification lookup-table data set 18 within database 5. Data set 18 may be continually updated as effects are observed and quantified, and changes in any frequency waves 3, 9, 12, and 13 which are output by generator 7 and transducers 6 are catalogued and altered to affect any specimen 20 toward a desired result.

Database 5 is structured as a continuously updateable database whose fields expand and records enlarge to encompass all changing data following frequency set 3 outputs generated by frequency generator 7 at and through a given specimen 20. Said data includes magnetic polarity changes, proton, neutron, and electron number and radiation shifts, and all spectral analysis changes following said shifts. The algorithm 11 required for building database 5 is considered a “neural net” type configuration, wherein a software program is designed to “learn” from its data inputs to generate new relevant data.

Database 5 may expand arithmetically or logarithmically as variations of frequency set 3 are defined, and the associated changes in transmitted, absorbed, and reflected frequency sets 9, 12, and 13 are catalogued and new variations of said frequency sets are applied. For example, to vaporize a piece of aluminum, it may be necessary to combine three base frequencies with fifty levels of harmonics, layered in non-uniform amplitudes, and coupled with multi-level shifted adjacent spectra, as well as an overdriven inverted base frequency wave combined with other dissonant frequency components to achieve the desired results.

Algorithm 11 may be configured to include the following information, logic elements, and operations, and software relationships within computer medium 15:

1. A database 5 of common periodic table atomic elements (specimen 20)—any individual element being identified as “y-yn”—is compiled with fields populated with known scientific information about said elements:
2. A frequency set 3 including frequencies DC and above, said frequencies x-xn able to be generated by a frequency generator 7 and transducer 6 combination, and said frequency sets 3 applied to any element (specimen 20) y-yn in a sweep over time starting at x and ending at xn.
3. If the amplitude of any frequency set 3, 9, 12, or 13 changes in response to any frequency set 3 x-xn, and is detected by any receiving transducer 8 or 10 coupled to a frequency amplitude analyzer 17 that is further electrically coupled to a computer 15 configured to collect the data from said actions, then the specific frequencies of sets 9, 12, and 13 at which said amplitude differential is observed—hereinafter described as “active frequencies”, may be generated individually in turn over a given time span, and transmitted through said specimen 20, and a first order harmonic x1-xn1 may be added to each of said active frequencies in turn over time. Additional harmonics x1n-xn1n may be added sequentially in turn over time up to the limits of the frequency generating equipment.
4. If the amplitude of any frequency set 9, 12, or 13 changes in response to any frequency x-xn+x1-xn1, then a second order harmonic x2-xn2 may be added to said frequency combination.
5. If the amplitude of any frequency set 3, 9, 12, or 13 becomes greater in response to any frequency x-xn+x1-xn1+x2-xn2, then a third order harmonic x3-xn3 may be added to said frequency combination.
6. This harmonic addition sequence may then be followed by identical addition sequences of inversion and dissonant variations of said frequency set 3, as well as harmonics of said frequency set 3 up to the limits of the frequency generator 7.
7. Concurrently, the wattage (power) applied to said frequency set 3, 9, 12, or 13 and said harmonic, inversion, and dissonant variations and additions of said frequency sets 3, 9, 12, or 13 may be lowered at the completion of each subsequent frequency addition and variation until no amplitude variation effect is observed, then the wattage applied to said frequency set 3, 9, 12, or 13 may be increased just until an amplitude variation is observed, and a new harmonic, inversion, or dissonant variation of said frequency set 3, 9, 12, or 13 may be applied to said specimen 20.

Those frequencies of said frequency set 3 that are absorbed by a specimen 20 are defined herein as its “active natural resonant” fundamental frequencies. “Overdriving” the amplitude of said frequencies with respect to the rate of absorption of any part of set 3 using frequency generator 7, may result in the modification of electrostatic, electromagnetic, or co-valent bonds within the atomic structure of specimen 20—in turn resulting in effects including crystallization, melting, shattering, and other state changes of the material. Further, the addition of frequency inversions, harmonics, dissonance, and offsets of said “overdriving” frequencies, to said overdriving frequencies, may result in further atomic component changes.

For any material or specimen 20, there is a “key” fundamental active natural resonant frequency which may be manipulated and augmented by the present invention to catalyze modification of the molecular structure. In the case of complex molecules, including organic tissues, there is a hierarchy of atomic elements which determine the mechanics of transmutation. Initially altering a single specific molecular or atomic structure within a specimen 20, and concurrently altering the ensuing applied frequencies, may then propagate state changes in all the associated structures. For example, if a molecule is comprised of ten atomic elements arranged in a particular way, modifying the polarity of the third most prevalent atomic element in the molecule will have a different effect than modifying the first most prevalent—and vice versa.

By manipulating all segments of the frequency spectrum, and applying open (no feedback sensing and responsive frequency tuning) and closed loop frequency feedback generation and modulation effects to the transmitted, reflected, absorbed, and especially active natural resonant frequency set 16 frequencies as they pass through atomic structures, atomic electromagnetic and structural changes may take effect. By classifying the changes—and rate of changes—in the reflected and transmitted frequencies, it may be possible to adjust the applied active frequencies to catalyze continuous, partial, or compound atomic and molecular changes. Arrays of frequencies 3, 9, 12, and 13 that may induce desired results in a specimen 20 are specified by system 15, and loaded back into broadband frequency generator 7 by system 15. Generator 7 energizes transducers 6 and the required modification of a specimen 20 may then be achieved by this closed loop frequency feedback mechanism.

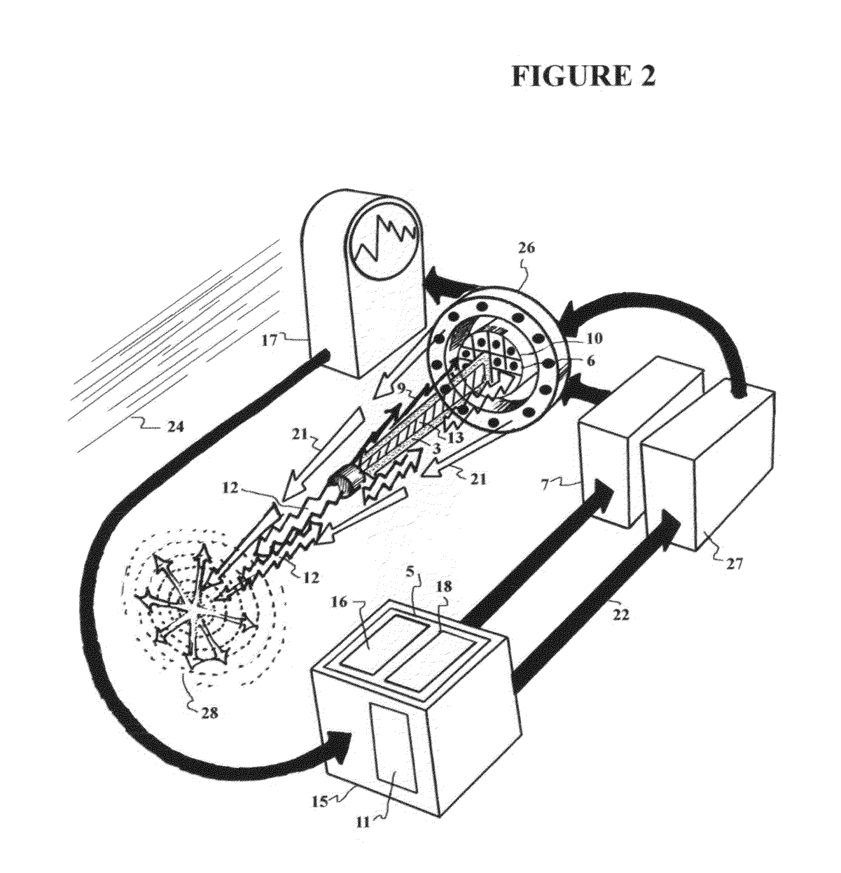

The self tuning frequency generator as presented in FIG. 2 is similar to that embodied in FIG. 1—except that no material analysis chamber is used. Numerical indicators relevant to apparatus elements used in FIG. 1 which are also used in FIG. 2 are maintained in FIG. 2. New elements are given new numbers. In this embodiment, a closed loop frequency feedback mechanism is described wherein a second frequency generating means 27, electrically coupled to system 15 and transducers 26, may be included, and said combination configured to transmit and project single or multiple frequency waves 21, combined with frequency inversions, and single or multiple harmonics, inversions, and dissonances of said frequency waves at variable amplitudes, at a given point in space separated from, but relative to the physical location of a specimen 20 to provide a resonant inverse barrier wave 28 tuned to create a frequency reflection effect in any ambient environment 24 surrounding said specimen 20 such that any transmitted frequency waves 12, output by transducer 6, that pass through said specimen 20, may be returned to, and sensed by transducer 10.

Prior art includes technologies which cancel sound waves and other frequency waves (radar jammers) by projecting a frequency wave set designed to negate another frequency wave set. Using a similar yet enhanced approach, the present invention utilizes a precisely structured wave set transmitted by frequency generator 27 that, in conjunction with the frequency transmission, absorption, and reflection characteristics of a given ambient environment 24, acts as a “frequency mirror” to reflect frequency waves propagated by frequency generator 7 back through transducers 10 to frequency analyzer 17 to increase the transmitted frequency wave 12 data relevant in database 5 to the composition of any specimen 20 which is located within ambient environment 24.

A frequency generator 27 may also be controlled by system 15 to create a frequency neutral “buffer” zone where frequency generator 7 outputs have no effect. In this usage, generator 27 may be configured to transmit and project single or multiple frequency waves 21, combined with single or multiple harmonics, inversions, and dissonances of said frequency waves through transducers 26 at variable amplitudes, at a given point in space separated from, but relative to the physical location of a specimen 20 to provide a neutral polarity buffer zone effect within a resonant inverse barrier wave 28 to allow a controlled ambient disconnection to exist between a specimen 20 and the ambient environment 24 by at least the space of one full atom or molecule during operation of the present invention. This effect may be especially useful in the spacecraft, land mine elimination, missile tracking and elimination, and sentient organism affecting methods presented in the present invention descriptions and claims.

The embodiments of the present invention as illustrated in FIGS. 1 and 2 are intended to allow observation of effects induced by combinations of frequencies on many types of materials. Additionally, many matter transformation effects may also be achieved including negative or positive electrostatic or electromagnetic polarization in a solid, liquid, or gaseous specimen 20. The range of effects and the level of accuracy of the present invention are predicated on the resolution of the frequency generators 7, and 27, and transducers 6, 8, 10, and 26, as well as the depth of resolution of database 5 and algorithm 11 for the structure of any specimen 20. The computational horsepower of computer system 15 is also not trivial. Since the invention is intended to provide real time atomic structure identification and manipulation, it is imperative that the computational portion of the system be configured for said purpose.

It is to be understood that the embodiments and variations shown and described herein are merely illustrative of the principles of this invention and that various modifications may be implemented by those skilled in the art without departing from the scope and spirit of the invention.

I claim:

1. A self tuning frequency generator comprising in combination:
At least one specimen analysis chamber comprising an interior space and an exterior shell;
At least one specimen retaining clamp mechanically located within said specimen analysis chamber;
At least one frequency generator capable of producing at least one frequency, as well as pluralities and combinations of harmonics, inversions, and dissonances of said first frequency in a range including DC and above;
At least one frequency transmitter transducer mechanically coupled inside said specimen analysis chamber, and electrically coupled to said at least one frequency generator, and configured to transmit said at least one frequency, as well as pluralities and combinations of harmonics, inversions, and dissonances of said at least one first frequency in a range including DC and above;
At least one frequency receiver transducer mechanically coupled inside said specimen analysis chamber, and capable of sensing said at least one first frequency, as well as pluralities and combinations of harmonics, inversions, and dissonances of said at least one first frequency in a range including DC and above;
At least one frequency analyzer electrically coupled to said at least one frequency receiver transducer, and capable of analyzing the amplitude, wave form, and electromagnetic characteristics of said at least one first frequency, as well as the amplitude, wave form, and electromagnetic characteristics of pluralities and combinations of harmonics, inversions, and dissonances of said at least one first frequency in a range including DC and above;
At least one computer medium electrically coupled to said frequency generator, said at least one frequency transmitter transducer, said at least one frequency receiver transducer, and said at least one frequency analyzer, and said computer medium incorporating at least one software database on a computer readable medium, said database including the known details of at least one atomic or molecular structure;
said computer medium also containing a software algorithm configured to modify the at least one first frequency output of said frequency generator to provide at least one variation of said at least one first frequency, as well as variations of pluralities and combinations of harmonics, inversions, and dissonances of said at least one first frequency in a range from DC and above.

2. A self tuning frequency generator according to claim 1 which integrates a visual observation mechanism.

3. A self tuning frequency generator according to claim 1 which includes a database of information of common periodic table atomic elements—any individual element being identified as a specimen “y-yn”—that has fields populated with known scientific information about said specimens;
said database incorporating a lookup table of frequencies including DC and above, said frequencies x-xn able to be generated by a frequency generator amplifier transducer combination, and said frequency patterns applied to any specimen y in a sweep over time starting at x and ending at xn;

4. A self tuning frequency generator according to claim 1 that incorporates an algorithm which requires that if the amplitude of any of said at least one frequency changes—in response to any frequency x-xn—and is detected by any said at least one frequency receiver transducer through said frequency amplitude analyzer electrically coupled to said computer medium configured to collect data from said actions, then the specific frequencies at which said amplitude differential is observed—hereinafter described as “active frequencies”, will be generated individually in turn over a given time span, and transmitted through said specimen y, and a first order harmonic x1-xn1 will be added to each of said active frequencies in turn over time. Additional harmonics x1n-xn1n will be added sequentially in turn over time up to the limits of the frequency generating equipment;
if the amplitude of any of said at least one frequency changes in response to any frequency x-xn+x1-xn1, then a second order harmonic x2-xn2 may be added to said frequency combination;
if the amplitude of said at least one frequency changes becomes greater in response to any frequency x-xn+x1-xn1+x2-xn2, then a third order harmonic x3-xn3 will be added to said frequency combination;
this harmonic addition sequence will be followed by identical addition sequences of inversion and dissonant variations of said at least one frequency and harmonics of said at least one frequency up to the limits of the frequency generating equipment;
concurrently, the wattage applied to said at least one frequency and said harmonic, inversion, and dissonant variations and additions will be lowered at the completion of each subsequent frequency addition and variation until no amplitude variation effect is observed, then the wattage applied to said at least one frequency will be increased just until an amplitude variation is observed, and a new harmonic, inversion, or dissonant variation of said at least one frequency will be applied to said specimen.

5. A self tuning frequency generator comprising in combination:
At least one frequency generator capable of producing at least one frequency, as well as pluralities and combinations of harmonics, inversions, and dissonances of said first frequency in a range including DC and above;
At least one frequency transmitter transducer electrically coupled to said at least one frequency generator, and configured to transmit said at least one frequency, as well as pluralities and combinations of harmonics, inversions, and dissonances of said at least one first frequency in a range including DC and above;
At least one frequency receiver transducer capable of sensing said at least one first frequency, as well as pluralities and combinations of harmonics, inversions, and dissonances of said at least one first frequency in a range including DC and above;
At least one frequency analyzer electrically coupled to said at least one frequency receiver transducer, and capable of analyzing the amplitude, wave form, and electromagnetic characteristics of said at least one first frequency, as well as the amplitude, wave form, and electromagnetic characteristics of pluralities and combinations of harmonics, inversions, and dissonances of said at least one first frequency in a range including DC and above;
At least one computer medium electrically coupled to said frequency generator, said at least one frequency transmitter transducer, said at least one frequency receiver transducer, and said at least one frequency analyzer, and said computer medium incorporating at least one software database on a computer readable medium, said database including the known details of at least one atomic or molecular structure;
said computer medium also containing a software algorithm configured to modify the at least one first frequency output of said frequency generator to provide at least one variation of said at least one first frequency, as well as variations of pluralities and combinations of harmonics, inversions, and dissonances of said at least one first frequency in a range from DC and above.

6. A self tuning frequency generator according to claim 5 which includes a database of information of common periodic table atomic elements—any individual element being identified as a specimen “y-yn”—that has fields populated with known scientific information about said specimens;
said database incorporating a lookup table of frequencies including DC and above, said frequencies x-xn able to be generated by a frequency generator amplifier transducer combination, and said frequency patterns applied to any specimen y in a sweep over time starting at x and ending at xn;

7. A self tuning frequency generator according to claim 5 that incorporates an algorithm which requires that if the amplitude of any of said at least one frequency changes—in response to any frequency x-xn—and is detected by any said at least one frequency receiver transducer through said frequency amplitude analyzer electrically coupled to said computer medium configured to collect data from said actions, then the specific frequencies at which said amplitude differential is observed—hereinafter described as “active frequencies”, will be generated individually in turn over a given time span, and transmitted through said specimen y, and a first order harmonic x1-xn1 will be added to each of said active frequencies in turn over time. Additional harmonics x1n-xn1n will be added sequentially in turn over time up to the limits of the frequency generating equipment;
if the amplitude of any of said at least one frequency changes in response to any frequency x-xn+x1-xn1, then a second order harmonic x2-xn2 may be added to said frequency combination;
if the amplitude of said at least one frequency changes becomes greater in response to any frequency x-xn+x1-xn1+x2-xn2, then a third order harmonic x3-xn3 will be added to said frequency combination;
this harmonic addition sequence will be followed by identical addition sequences of inversion and dissonant variations of said at least one frequency and harmonics of said at least one frequency up to the limits of the frequency generating equipment;
concurrently, the wattage applied to said at least one frequency and said harmonic, inversion, and dissonant variations and additions will be lowered at the completion of each subsequent frequency addition and variation until no amplitude variation effect is observed, then the wattage applied to said at least one frequency will be increased just until an amplitude variation is observed, and a new harmonic, inversion, or dissonant variation of said at least one frequency will be applied to said specimen.
